(19) United States
(12) Patent Application Publication
(10) Pub. No.: US 2024/0425644 A1
(43) Pub. Date: Dec. 26, 2024

(54) PROCESS FOR THE PRODUCTION OF POLYESTER COPOLYMERS

(71) Applicant: Avantium Knowledge Centre B.V., Amsterdam (NL)

(72) Inventors: Bing WANG, Amsterdam (NL); Gerardus Johannes Maria Gruter, Amsterdam (NL); Robert-Jan VAN PUTTEN, Amsterdam (NL)

(21) Appl. No.: 18/294,919

(22) PCT Filed: Aug. 1, 2022
(86) PCT No.: PCT/EP2022/071586

§ 371 Date: Feb. 2, 2024

(30) Foreign Application Priority Data
Aug. 4, 2021 (EP) 21189200.5

(51) Int. Cl. C08G 63/85; C08G 63/91

(52) U.S. Cl. CPC C08G 63/85; C08G 63/916

(57) ABSTRACT

A polymerization process for the production of a polyester copolymer A comprising simultaneously reacting a polyester (i) with one or more diols (ii) and one or more dicarboxylic acids or any esters thereof (iii), wherein the polyester (i) is polyethylene terephthalate, polyethylene furanoate, a mixture of polyethylene terephthalate and polyethylene furanoate, or polyethylene terephthalate-co-furanoate; and wherein no terephthalic acid or ester thereof is added as a dicarboxylic acid or ester thereof (iii) if the polyester (i) is polyethylene terephthalate; and wherein the one or more diols (ii) is/are selected from primary diols selected from C3-C18 aliphatic diols; and wherein the components (i) and (ii) are used in sufficient quantities to produce a polyester copolymer A comprising at least 40 mole % of ethylene glycol derived from the starting polyethylene terephthalate, polyethylene furanoate or polyethylene terephthalate-co-furanoate, and at least 5 mole %, preferably equal to or more than 10 mole %, of monomers derived from said primary diols, the percentages based on the total amount of diol-derived monomer units in polyester copolymer A; and wherein the process comprises heating the polyester (i), the one or more primary diols (ii) and the one or more dicarboxylic acids or any esters thereof (iii) to form a melt; to generate a polyester A comprising monomer units derived from the polyester (i), from the one or more primary diols (ii) and from the one or more dicarboxylic acids or any esters thereof (iii), having a number average molecular weight, as measured by gel permeation chromatography with PMMA standards as reference material, of 16500 daltons or more.

### FIELD OF THE INVENTION

The invention relates to a polymerization process for the production of a polyester copolymer comprising reacting a polyester with one or more diols and one or more dicarboxylic acids or esters thereof, a novel polyester copolymer obtainable by said method, a composition comprising said novel polyester copolymer, and an article comprising said novel polyester copolymer.

### BACKGROUND OF THE INVENTION

Polyethyleneterephthalate (PET) is an important polymer material and currently is the second largest in volume of the ‘big 5’ plastics, with a global annual production of around 80 million tons [www.textileworld.com/textile-world/features/2019/07/challenges-facing-recycled-polyester/]. The most common PET applications are fibres (textiles; 56 million tons/yr) and single-use packaging such as bottles (20 million tons/yr), engineering plastics and films. The rapid development of the PET industry globally has led to an increase of PET waste. A lot of pollution, especially in the oceans, is caused by PET waste. As a consequence, there is a need for recycling and reuse of waste PET products which will not only reduce consumption of fossil raw materials, but also will have a positive impact on the environment. Creating a recyclable renewable industry is of great significance to the sustainable development of polyester materials. However, because of the purity requirements, today only about 3% of all PET (2 million tons per year) is closed-loop mechanically recycled, producing rPET (recycled PET) for bottles. The remaining 78 million tons of PET waste is landfilled, open-loop recycled (down cycled—e.g. bottle-to-fibre), incinerated, at best with energy recovery, or ends up in nature. This is estimated to be at least 8 million tons mixed plastic waste per year (World Economic Forum, Ellen Macarthur Foundation and Mckinsey & Company, The New Plastics Economy—Rethinking the future of plastics [2016, http://www.ellenmacarthurfoundation.org/publications]).

There is still a need for the use of PET waste material in new, economically interesting processes, particularly with the aim to produce attractive higher value derivatives of PET, for example with better biodegradability, thus for “upcycling” the PET material. By effectively using waste plastics as a preferred resource for the production of new plastics, a serious contribution can be made to a required acceleration of the transition from a linear plastics use to a truly circular use of plastics in 2050.

Unfortunately, the cost of the mechanical recycling process makes recycled PET (or rPET) more expensive than so-called “virgin” (i.e. newly produced) PET. Several chemical recycling technologies are currently in development such as Cure [https://curetechnology.com/] and loniqa [https://ioniqa.com/] in the Netherlands, in which PET is depolymerized to oligomers or to its monomers, allowing “cleaning” and also resulting in closed-loop recycling. However, the resulting chemically recycled rPET is still more expensive than virgin fossil PET. In addition, there are various other new PET recycling initiatives e.g. by companies such as Carbios, GR3N, Loop Industries and Resinate Materials Group, which however only target improving the recycling process and lowering recycling cost.

Chemical recycling of PET needs further exploring. Polyesters like PET are uniquely positioned for the chemical recycling/upcycling approach as ester bonds can be hydrolysed (with water, back to the original acid and alcohol) or trans-esterified (typically with alcohols, back to esters of the original acid and alcohol) or trans-esterified with other monomers) to produce copolyesters. An advantage of a chemical recycling approach is that ester bonds already present in the waste PET are used, thus conserving the energy invested in their production (as high temperatures and low pressures are required to remove condensation products such as water and methanol and to remove excess diol).

The re-use of PET is of particular interest if the material is upgraded by introduction of, preferably more sustainable, additional monomer units. An interesting class of PET copolymers with additional monomer units are PEXT copolymers, wherein X is a monomer derived from cyclic or bicyclic (secondary) diols. Such copolymers have improved properties, like higher rigidity and/or better biodegradability, introduced by said diols. For example, CHDM (cyclohexanedimethanol) or TMCD (tetramethylcyclobutanediol) are specialty diols used in such copolymers. Further, polyethylene terephthalate containing isosorbide (PEIT) polymers are desirable, as isosorbide is produced from renewable sources. PEIT copolymers are known to exhibit a wide range of glass transition temperatures (as from 80 up to 180° C.) and are therefore suitable for use in many applications (see e.g. Polymer Engineering and Science, March 2009, 49(3):544-553).

Recently, CN112608454 reported a process for preparing a non-crystalline copolyester PETG by using recycled PET plastics. PETG is an amorphous copolyester material produced by introducing monomer fragments (here G) that effectively control crystallinity into the molecular structure of PET. The monomer fragment G in the CN112608454 disclosure is derived from (a mixture of) the so-called “modified” glycols cis 1,4-cyclohexanedimethanol, trans 1,4-cyclohexanedimethanol, and neopentyl glycol. The process of CN112608454 starts with simultaneously slurrying waste PET, as the raw starting material, and ethylene glycol with terephthalic acid, or terephthalate, or a mixture of terephthalic acid and terephthalate, together with the so-called “modified” glycols, catalysts and stabilizers, optionally in the presence of additional diacids and “other” glycols, followed by a degradation/esterification reaction at high temperature, to end with a vacuum polymerization, to generate a low molecular weight ester.

In another disclosure, KR20150053502A describes chemical recycling of PET, and subsequently conversion into an unsaturated polyethylene terephthalate derived resin. The process of KR20150053502A comprises subjecting a PET oligomer to glycolysis with a glycol selected from ethylene glycol (EG), diethylene glycol (DEG) and propylene glycol (PG), followed by calculating the amount of glycol to be added to the actual reaction by analyzing the unreacted glycol content through 13C NMR analysis of the reactants produced in the first reaction step; then-based on the calculated content-adding into the reactants produced in the first reaction step, at least one selected from ethylene glycol and propylene glycol, and also unsaturated acids, maleic acid and phthalic acid. In a further reaction step the unsaturated polyester resin is synthesized.

It is notable, that although in the prior art step-growth polymerization techniques already have been used for the production of PET copolymers, several challenges encountered with the process have given rise to the need for development of new synthetic strategies. Further, there is a need for new copolymers with properties that may be tailored to specific uses and/or applications.

It would be advantageous to provide a chemical PET recycling/upcyling process in which preferably sustainable monomers are introduced into (waste) PET, to produce new copolyesters with improved properties, such as better mechanical, thermal, barrier and caustic resistance properties when compared to PET. The polyester PET itself is not biodegradable. Therefore, it would further be an advancement to be able to produce high value, biodegradable (and preferably marine degradable) polyester copolymers, for which there is huge interest in the market.

### SUMMARY OF THE INVENTION

Accordingly, the present invention provides a polymerization process for the production of a polyester copolymer A comprising simultaneously reacting a polyester (i) with one or more diols (ii) and one or more dicarboxylic acids or any esters thereof (iii), wherein the polyester (i) is polyethylene terephthalate (PET), polyethylene furanoate (PEF), a mixture of polyethylene terephthalate and polyethylene furanoate, or polyethylene terephthalate-co-furanoate (PETF) (preferably polyethylene furanoate or polyethylene terephthalate-co-furanoate); and wherein no terephthalic acid or ester thereof is added as a dicarboxylic acid or ester thereof (iii) if the polyester (i) is polyethylene terephthalate; and wherein the one or more diols (ii) is/are selected from primary diols selected from C3-C18 aliphatic diols; and wherein the components (i) and (ii) are used in sufficient quantities to produce a polyester copolymer A comprising at least 40 mole % of ethylene glycol derived from the starting polyethylene terephthalate, polyethylene furanoate or polyethylene terephthalate-co-furanoate, and at least 5 mole %, preferably equal to or more than 10 mole %, of monomers derived from said primary diols, the percentages based on the total amount of diol-derived monomer units in polyester copolymer A; and wherein the process comprises heating the polyester (i), the one or more primary diols (ii) and the one or more dicarboxylic acids or any esters thereof (iii) to form a melt; to generate a polyester A comprising monomer units derived from the polyester (i), from the one or more primary diols (ii) and from the one or more dicarboxylic acids or any esters thereof (iii), having a number average molecular weight, as measured by gel permeation chromatography with PMMA standards as reference material, of 16500 daltons or more . . . .

Contrary to several PET recycling/degradation processes known in the art, in the current process no ethylene glycol is added for the (initial) degradation of the PET polymeric chain. Surprisingly, it was found that when PET, PEF, a mixture of PET and PEF, or PETF, the one or more primary diols (ii) and the and one or more dicarboxylic acids or any esters thereof (iii) are reacted together in a so-called “one-pot” reaction (either batch or continuous), simultaneous depolymerization/transesterification takes place, resulting in a polyester copolymer that comprises significant quantities of monomer units derived from said diol(s) and from said dicarboxylic acid(s) or ester(s) thereof. Advantageously, according to the process of the invention, the dicarboxylic acid (required to match the one to one diol to dicarboxylic acid ratio) is already present from the start of the reaction, allowing an efficient, concerted, “one-in-all”, process. No multiple step polymerization as known from the prior art, is needed to control the formation of the polyester copolymer.

As a further advantage over prior art processes, the process of the present invention allows for the preparation of PET-derived polyester copolymers comprising monomer units derived from renewable materials, while obtaining high number average molecular weights of the polyester end product.

According to the process of this disclosure, by further combining additional diacids in the process, a huge variety of polyester copolymers may be produced, having tunable properties. Notably, the process of the invention is suitable for the production of a wide range of both existing and novel copolymers. Consequently, in an embodiment, the present invention provides novel polyester copolymers. Advantageously, by using the process of the present invention, it is possible to produce a 100% sustainable, flexible, strong and potentially biodegradable, copolyester for applications such as packaging and/or fibers.

In addition, the invention provides a composition comprising any one of said novel polyester copolymers A and in addition one or more additives and/or one or more additional polymers.

Further, the invention provides an article comprising the polyester copolymer A according to the invention or a composition comprising said polyester copolymer A and one or more additives and/or additional polymers.

### DETAILED DESCRIPTION OF THE INVENTION

The present invention relates to a polymerization process for the production of a polyester copolymer. By a “polyester” herein is understood a polymer comprising a plurality of monomer units linked via ester functional groups in its main chain. An ester functional group can be formed by reacting an hydroxyl group (—OH) with a carboxyl/carboxylic acid group (—C(═O) OH). Typically, a polyester is a synthetic polymer formed by the reaction of one or more bifunctional carboxylic acids with one or more bifunctional hydroxyl compounds. By a polyester copolymer is herein understood a polyester wherein three or more types of monomer units are joined in the same polymer main chain.

By a “monomer unit” is herein understood a unit as included in the polyester copolymer, which unit can be obtained after polymerization of a monomer, that is, a “monomer unit” is a constitutional unit contributed by a single monomer or monomer compound to the structure of the polymer, herein the smallest diol or di-acid repeating unit. By a “monomer” or “monomer compound” is herein understood the smallest diol or di-acid compound used as the starting compound to be polymerized.

The polymerization process according to the invention comprises heating the mixture of polyester (i), the one or more primary diols (ii) and the one or more dicarboxylic acids or any esters thereof (iii) to form a melt, which means melt mixing of the materials, i.e. heating all materials in the reaction mixture until they are all in a molten state, as a clear liquid. Optionally, a metal-containing catalyst is added to the reaction mixture. The melt mixing of the reagents (i), (ii) and (iii), is typically done at a temperature in the range from equal to or higher than 200° C., more preferably equal to or higher than 230° C., to equal to or lower than 300° C., more preferably equal to or lower than 275° C., and even more preferably equal to or lower than 250° C. The melt mixing can be carried out, e.g. batch-wise, in a reactor. The melt mixing May be preceded by an introduction stage, wherein the reagents are introduced into a reactor, and the melt mixing is succeeded by an esterification/transesterification stage, followed by a polycondensation stage until a desired molecular weight of Mn>16500 dalton is obtained, and further a recovery stage may follow, wherein the polyester copolymer is recovered from a reactor. The melt polymerization process of the present disclosure may also be carried out in a continuous process.

In the currently claimed process, no ethylene glycol is added as a diol (ii). Thus, all ethylene glycol-derived monomer units in the produced polyester copolymer A are derived from the starting polyester (i), which already comprises ethylene glycol-derived monomer units.

In the process of the invention, the one or more primary diols (ii) is/are selected from C3-C18 aliphatic diols, in particular from linear, cyclic or branched, saturated C3-C12 aliphatic diol compounds, the hydroxyl groups preferably being at least attached to non-neighboring carbon atoms, and preferably from 1,3-propanediol, 1,4-butanediol, 1,5-pentanediol, 1,6-hexanediol, diethyleneglycol, neopentylglycol, cyclohexanedimethanol, and acetals of polyols, especially C6 polyols, and particularly 2,3:4,5-di-O-methylene-galactitol, 2,4:3,5-di-O-methylene-D-mannitol, 2,4:3,5-di-O-methylene-D-glucitol (glucitol=sorbitol), 2,3:4,5-di-O-isopropylidene-galactitol, 2,4:3,5-di-O-isopropylidene-D-mannitol and 2,4:3,5-di-O-isopropyli-dene-D-glucitol. In the process also a mixture of primary diols may be used. A particularly preferred primary diol is cyclohexanedimethanol.

According to the process of the invention, conveniently certain properties of the produced polyester copolymer, such as the Tg, barrier, mechanical, biodegradability and other properties, can be targeted to desired values/levels by tuning the selection of the type and amount of one or more primary diols (ii) during the process, but also by tuning the selection of the type and amount of the one or more dicarboxylic acids or any esters thereof (iii). According to the process this disclosure, polyester copolymers with a commercially interesting number average molecular weight may be obtained within commercially advantageous reaction times.

As said, also the type and amount of the (iii) one or more dicarboxylic acids or any esters thereof will have a tuning effect on the properties of the produced polyester copolymer A. In particular, the one or more dicarboxylic acids or any esters thereof (iii) is/are selected from one or more of furandicarboxylic acid (FDCA), isophthalic acid, C2-C18 (preferably C2-C12) aliphatic dicarboxylic acids which may be linear, cyclic or branched and preferably saturated, and/or monoesters and/or diesters thereof, and if polyester (i) is polyethylene furanoate the dicarboxylic acid or any esters thereof (iii) can also be terephthalic acid and/or monoesters and/or diesters thereof. For targeting flexible copolymers, preferably linear C2-C12 aliphatic dicarboxylic acids are selected, such as oxalic acid, malonic acid, butanedioic acid (succinic acid), pentanedioic acid (glutaric acid), hexanedioic acid (adipic acid), heptanedioic acid, octanedioic acid (suberic acid), nonanedioic acid, decanedioic acid, undecanedioic acid and dodecanedioic acid, and/or monoesters and/or diesters thereof, such as for example dialkyl esters of such C2-C12 aliphatic dicarboxylic acids, wherein the alkyl groups comprise in the range from 1 to 6 carbon atoms. Also FDCA and/or isophthalic acid can be used for that purpose. Preferred are oxalic acid, succinic acid and adipic acid, FDCA and/or ester derivatives thereof.

In the process of the invention, preferred combinations of primary diols (ii) and dicarboxylic acids (iii) are selected from cyclohexanedimethanol and succinic acid; and 1,4-butanediol or 1,6-hexanediol, respectively, combined with furandicarboxylic acid or succinic acid, respectively.

In a particularly preferred embodiment of process of the invention, the one or more primary diols (ii) and the one or more dicarboxylic acids or any esters thereof (iii) are used in the process in a molar ratio of the total sum of diols to the total sum of dicarboxylic acids or any esters thereof of 1.5:1.0 to 1.0:1.0.

Preferably, the diols and/or diacids used in the current process are obtained and/or derived from a renewable source, e.g. sustainable biomass material. By a biomass material is herein understood a composition of matter obtained and/or derived from a biological source as opposed to a composition of matter obtained and/or derived from petroleum, natural gas or coal. The biomass material can for example be a polysaccharide, such as starch, or a cellulosic and/or lignocellulosic material. By sustainable is herein understood that the material is harvested and/or obtained in a manner such that the environment is not depleted or permanently damaged. Sustainable biomass material may for example be sourced from forest waste, agricultural waste, waste paper and/or sugar processing residues.

In a preferred embodiment of the process of the invention, the polyester (i) is polyethylene terephthalate (PET). This means that the polyester is essentially PET with optionally only traces of other compounds. The polyester (i) used as starting material in the process may be provided in the form of a material comprising said polyester (i), especially with a consistent high quality of the polyester. The material advantageously is a recycled material. Preferably, the material comprising PET is predominantly recycled PET, in particular PET scrap. To avoid any misunderstanding, also non-recycled PET (i.e. virgin PET) may be used instead of recycled PET.

In another preferred embodiment of the invention, the polyester (i) is polyethylene furanoate (PEF) or polyethylene terephthalate-co-furanoate (PETF) instead of polyethylene terephthalate. In case the polyester is PEF, this means that the polyester is essentially PEF with optionally only traces of other compounds. PEF is an aromatic polyester made of ethylene glycol and 2,5-furandicarboxylic acid and is a chemical analogue of PET. PEF may be fully biobased material and offers in addition to a better carbon foot print, superior barrier, mechanical and thermal properties when compared to PET. PEF is an ideal material for a wide range of applications such as in the packaging industry for alcoholic beverages, fruit juices, milk, soft drinks, fresh tea or water. Like PET, PEF may be available in the form of “virgin” and “recycled” material. When PEF is abundantly available, preferably, the polyester (i) may be material comprising predominantly waste PEF, in particular PEF scrap. Preferably, the polyester copolymer PETF as used herein comprises a ratio of terephthalate to furanoate monomers (T:F)>1, preferably T:F>2, and more preferred T:F>5.

Generally, the Mn of the starting PET or PEF is at least 10000 daltons.

As said, in the process of the invention, it is also possible that the polyester (i) comprises a mixture of PEF and PET. In such a case, a combination of at least 95% by weight of PET and at most 5% by weight of PEF is preferred, or a combination of at least 95% by weight of PEF and at most 5% by weight of PET.

In a further embodiment of the invention, in the process also, in addition to the polyester (i), the one or more primary diols (ii) and the one or more dicarboxylic acids or any esters thereof (iii), a monohydric alcohol may be added in which the hydroxy group is the only reactive functional group, in 10-100 weight % with regard to the total weight of the other reactants (i), (ii) and (iii), wherein the monohydric alcohol has a boiling point of equal to or higher than 175° C. and an acid dissociation constant (pKa) of equal to or less than 12.0 and equal to or more than 7.0. In particular, the monohydric alcohol is an optionally substituted phenol, such as phenol, p-alkylphenol, p-alkoxyphenol, guaiacol, etc., The addition of the monohydric alcohol may take place before the reaction starts, e.g. preferably by first mixing PET and/or PEF with the alcohol, but it may also be added in a later stage during the reaction, or both at the start and during the reaction, whenever required. The monohydric alcohol may serve as a reactive diluent in the reaction mixture, which may be desirable or considered necessary under certain circumstances. For instance, when using monohydric alcohol in the presently claimed process, and when compared to multi-step polymerization techniques known in the art which start solely from a mixture of monomers, less of the diol monomers may be lost during polymerization, and more thereof may be incorporated in the resulting polyester copolymer.

The amounts of each of the different monomeric units in the produced polyester copolymer can be determined by proton nuclear magnetic resonance (¹H NMR). One skilled in the art would easily find the conditions of analysis to determine the amount of each of the different monomer units in the polyester copolymer.

The polyester copolymer(s) A produced according to the process of to the invention can be random copolymers or can have a more blocky microstructure. Since the (novel) copolymers A are not solely produced from monomers, but also from PET and/or PEF as starting materials the copolymer A may for example comprise two or more homopolymer subunits linked by covalent bonds.

The number average molecular weight (Mn) of the polyester copolymer(s) A may vary and may depend for example on the added monomer type and amount, the catalyst, the reaction time and reaction temperature and pressure.

The polyester copolymer(s) A according to the invention preferably has/have a number average molecular weight of equal to or more than 16500 grams/mole, more preferably of equal to or more than 20000 grams/mole up to at most 200000 grams/mole.

The weight average molecular weight (Mw) and the number average molecular weight (Mn) can be determined by means of gel permeation chromatography (GPC) at 35° C., using for the calculation poly(methyl methacrylate) standards as reference material, and using hexafluoro-2-propanol as eluent. All molecular weights herein are determined as described under the analytical methods section of the examples.

Suitably the polyester copolymer A according to the present invention may have a polydispersity index (that is, the ratio of weight average molecular weight (Mw) to number average molecular weight (Mn), i.e. Mw/Mn) in the range from equal to or more than 1.6 to equal to or less than 2.6.

The glass transition temperature of the polyester copolymer A can be measured by conventional methods, in particular by using differential scanning calorimetry (DSC) with a heating rate of 10° C./minute in a nitrogen atmosphere. All glass transition temperatures herein are determined as described under the analytical methods section of the examples.

Biodegradability is an important and interesting property of plastics that is currently widely investigated, and is also the property that the present invention seeks to improve by providing new polymers. Biodegradable plastics are plastics that can be decomposed by the action of living organisms, usually microbes, into water, carbon dioxide, and biomass. Biodegradable plastics are commonly used for disposable items, such as packaging, crockery, cutlery, and food service containers. However, plastic items labelled as “biodegradable”, but which items only break down into smaller pieces like microplastics, or into smaller units that are not biodegradable, are not an improvement over conventional plastics. Notably, the problem with the term “biodegradability” is that it is a “system property”. That is, whether a particular plastic item will biodegrade depends not only on the intrinsic properties of the item, such as the chemical composition and physical appearance (shape, thickness, surface area, etc), but also on the conditions in the environment in which it ends up. The rate at which plastic biodegrades in a specific ecosystem depends on a wide range of environmental conditions, including temperature, humidity, UV-light, and the presence of specific microorganisms.

Home compostable plastics are polymers that (simply said) degrade to CO₂, water and biomass (in aerobic conditions) by means of microorganisms, same rate or faster than cellulose (wood) at ambient temperature in 12 months in soil (e.g. PHA's). At the time of writing, there is no European standard for home compostability and the French standard AFNOR NF T 51-800 should be considered for home compostability requirements.

Industrially compostable plastics are polymers that (simply said) degrade to CO₂, water and biomass (in aerobic conditions) by means of microorganisms, at >50° C. in 6 months in soil (e.g. PLA). EN 13432 or equivalent standards (e.g. ISO 18606) should be considered for industrial compostability requirements.

It should be noted that there are also plastics that are not bio-degradable (according to home- or industrial compostability) but that degrade (much) faster than conventional polymers in nature. E.g. PEF degrades within years, while PET degrades in centuries. Although PEF is not a biodegradable plastic, it's degradation within years will still avoid endless accumulation of these plastics after leaking into the environment.

A suitable and advantageous way to perform the process of the invention comprises the following steps: (a) in a reaction vessel heating the polyester (i), the one or more primary diols (ii) and the one or more dicarboxylic acids or any esters thereof (iii) to a certain temperature for a certain period of time until a clear melt (liquid) forms; (b) continuing the esterification/transesterification reaction (under stirring) while removing condensation products products (like water, alcohol) at a pressure of 1 to 5 bar; (c) reducing the pressure in the vessel of step (b) to a vacuum of lower than 20 mbar, preferably lower than 10 mbar, more preferably lower than 5 mbar, and particularly lower than 1 mbar, with continued stirring for a certain period of time (polycondensation); and optionally during step (c) further increasing the temperature by 10 to 50° C.—to facilitate removal of remaining condensation products from the reactor.

The process according to the invention can be carried out in a batch-wise, semi-batchwise or continuous mode. The esterification/transesterification stage and the polycondensation stage may conveniently be carried out in one and the same reactor, but may also be carried out in two separate reactors, for example where the esterification/transesterification stage is carried out in a first esterification/transesterification reactor and the polycondensation stage is carried out in a second polycondensation reactor.

In any introduction stage, the monomers may be introduced into the reactor simultaneously, for example in the form of a feed mixture, or in separate parts. The monomers may be introduced into the reactor in a molten phase or they can be molten and mixed after introduction into the reactor.

Any esterification/transesterification stage is preferably carried out in a reaction time in the range from equal to or more than 0.5 hour, more preferably equal to or more than 1.0 hour, to equal to or less than 6.0 hour, more preferably equal to or less than 4.0 hour. During a esterification/transesterification stage, the temperature may be stepwise or gradually increased.

Any polycondensation stage is preferably carried out in a reaction time in the range from equal to or more than 0.5 hour, more preferably equal to or more than 1.0 hour, to equal to or less than 8.0 hours, more preferably equal to or less than 6.0 hours. During a polycondensation stage, the temperature may be stepwise or gradually increased.

The polycondensation stage may suitably be carried out at a temperature equal to or higher than the temperature at which the transesterification stage is carried out. The transesterification stage may for example be carried out at a temperature in the range from equal to or higher than 200° C., more preferably equal to or higher than 210° C., and even more preferably equal to or higher than 230° C., to equal to or lower than 250° C. The polycondensation stage may suitably succeed the transesterification stage and the polycondensation stage can for example be carried out at a temperature in the range from equal to or higher than 250° C., more preferably equal to or higher than 265° C., to equal to or lower than 300° C., more preferably equal to or lower than 285° C. and most preferably equal to or lower than 275° C.

The polycondensation stage may be succeeded by a recovery stage, wherein the polyester copolymer A is recovered from the reactor. The polyester can for example be recovered by extracting it from the reactor in the form of a string of molten polymer. This string can be converted into granules using conventional granulation techniques.

The esterification/transesterification stage suitably may be carried out under an inert gas atmosphere, suitably at ambient pressure or slightly above that, e.g. up to 5 bar. The polycondensation stage suitably is carried out at a reduced pressure. Preferably, the polycondensation stage may be carried out at a pressure in the range from equal to or more than 0.01 mbar (corresponding to 1 Pascal), more preferably equal to or more than 0.1 mbar (corresponding to 10 Pascal) to equal to or less than 10.0 mbar (corresponding to 1.0 KiloPascal), more preferably equal to or less than 5.0 mbar (corresponding to 500 Pascal).

The process according to the invention may be carried out in the presence of one or more additives, such as stabilizers, for example light stabilizers, UV stabilizers and heat stabilizers, fluidifying agents, flame retardants and antistatic. Phosphoric acid is an example of a stabilizer applied in PET. Additives may be added at the start of the process, or during or after the polymerization reaction. Other additives include primary and/or secondary antioxidants. A primary antioxidant can for example be a sterically hindered phenol, such as the compounds Hostanox® 0 3, Hostanox® 0 10, Hostanox@ 0 16, Ultranox® 210, Ultranox®276, Dovernox® 10, Dovernox® 76, Dovernox® 3114, Irganox® 1010 or Irganox® 1076. A secondary antioxidant can for example be a trivalent phosphorous-comprising compounds, such as Ultranox® 626, Doverphos@ S-9228 or Sandostab® P-EPQ.

The process according to the invention is suitably carried out in the presence of a metal-containing catalyst. Such metal-containing catalyst may for example comprise derivatives of tin (Sn), titanium (Ti), zirconium (Zr), germanium (Ge), antimony (Sb), bismuth (Bi), hafnium (Hf), magnesium (Mg), cerium (Ce), zinc (Zn), cobalt (Co), iron (Fe), manganese (Mn), calcium (Ca), strontium (Sr), sodium (Na), lead (Pb), potassium (K), aluminium (Al), and/or lithium (Li). Examples of suitable metal-containing catalysts include salts of Li, Ca, Mg, Mn, Zn, Pb, Sb, Sn, Ge, and Ti, such as acetate salts and oxides, including glycol adducts, and Ti alkoxides. Examples of such compounds can, for example, be those given in US2011282020A1 in sections [0026] to [0029], and on page 5 of WO 2013/062408 A1. Preferably the metal-containing catalyst is a tin-containing catalyst, for example a tin (IV)- or tin (II)-containing catalyst. More preferably the metal-containing catalyst is an alkyltin (IV) salt and/or alkyltin (II) salt. Examples include alkyltin (IV) salts, alkyltin (II) salts, dialkyltin (IV) salts, dialkyltin (II) salts, trialkyltin (IV) salts, trialkyltin (II) salts or a mixture of one or more of these. These tin (IV) and/or tin (II) catalysts may be used with alternative or additional metal-containing catalysts. Examples of alternative or additional metal-containing catalysts that may be used include one or more of titanium (IV) alkoxides or titanium (IV) chelates, zirconium (IV) chelates, or zirconium (IV) salts (e.g. alkoxides); hafnium (IV) chelates or hafnium (IV) salts (e.g. alkoxides); yttrium (III) alkoxides or yttrium (III) chelates; lanthanum (III) alkoxides or lanthanum chelates; scandium (III) alkoxides or chelates; cerium (III) alkoxides or cerium chelates. An exemplary and preferred metal-containing catalyst is n-butyltinhydroxide oxide.

The process according to the invention may optionally further comprise, after a recovery stage (i.e. wherein the polyester copolymer is recovered from the reactor) as described above, a stage of polymerization in the solid state. That is, the polyester copolymer recovered as described above may be polymerized further in the solid state, thereby increasing chain length. Such polymerization in the solid state is also referred to as a solid state polymerization (SSP). Such a solid state polymerization advantageously allows one to further increase the number average molecular weight of the polyester copolymer. If applicable, SSP can further advantageously enhance the mechanical and rheological properties of polyester copolymers before injection blow molding or extruding. The solid state polymerization process preferably comprises heating the polyester copolymer in the essential or complete absence of oxygen and water, for example by means of a vacuum or purging with an inert gas.

Advantageously the process according to the invention can therefore comprise:
a melt polymerization wherein the above described monomers are polymerized in a melt to produce a polyester copolymer melt product;
an optional pelletisation wherein the polyester copolymer melt product is converted into pellets, and the optional drying of the pellets under vacuum or with the help of inert gas purging;
an optional solid state polymerization of the polyester copolymer melt product, optionally in the form of pellets, at a temperature above the Tg of the polyester copolymer melt product and below the melt temperature of the polyester copolymer melt product.

Generally, the solid state polymerization may suitably be carried out at a temperature in the range from equal to or more than 150° C. to equal to or less than 220° C. The solid state polymerization may suitably be carried out at ambient pressure (i.e. 1.0 bar atmosphere corresponding to 0.1 MegaPascal) whilst purging with a flow of an inert gas (such as for example nitrogen or argon) or may be carried out at a vacuum, for example a pressure equal to or below 100 millibar (corresponding to 0.01 MegaPascal). The solid state polymerization may suitably be carried out for a period up to 120 hours, more suitably for a period in the range from equal to or more than 2 hours to equal to or less than 60 hours. The duration of the solid state polymerization may be tuned such that a desired final number average molecular weight for the polyester copolymer is reached.

The present invention further provides a polyester copolymer obtainable by, or in particular obtained by, a process according to the invention. In particular preferred are polyester copolymers comprising monomer units derived from said primary diol (especially diethyleneglycol, cyclohexanedimethanol, 1,4-butanediol, 1,5-pentanediol and/or 1,6-hexanediol) in 10-60 mole % (on the basis of total diol); and in particular polyester copolymers comprising a combination of cyclohexanedimethanol (CHDM) and succinic acid (SA), and combinations of diethyleneglycol (DEG), 1,4-butanediol (BDO), 1,5-pentanediol (PDO) or 1,6-hexanediol (HDO) combined with furandicarboxylic acid (FDCA), adipic acid (AD) or succinic acid. Such polyester copolymers have particularly interesting biodegradability properties.

Non-limiting examples of novel polyester copolymers A according to the invention include (wherein mole % is on the basis of total diol, diacid, respectively):
PEDTA and PEDFA (i.e. a polyester copolymer prepared from PET or PEF, respectively, with 10-60 mole % of DEG and 10-60 mole % of AD);
PECTS, PEBTF (or PEPTF or PEHTF), PEBTS (or PEPTS or PEHTS) (i.e. a polyester copolymer prepared from PET+10-60 mole % of CHDM or BDO (or PDO or HDO), respectively, +10-60 mole % of SA or FDCA, respectively);
PECFS, PEBFS (or PEPFS or PEHFS), PEBF (or PEPF or PEHF) (i.e. a polyester copolymer prepared from PEF+10-60 mole % of CHDM or BDO (or PDO or HDO), respectively, +10-60 mole % of SA or FDCA, respectively);
specifically, a PECTS, PEBTF (or PEPTF or PEHTF) or PEBTS (or PEPTS or PEHTS), polyester copolymer prepared from PET with an amount of CHDM or BDO (or PDO or HDO), respectively, equal to that of SA or FDCA, respectively, and >5 mole %; and a PECFS, PEBFS (or PEPFS or PEHFS) or PEBF (or PEPF or PEHF) polyester copolymer prepared from PEF with amount of CHDM or BDO (or PDO or HDO), respectively, equal amount to that of SA or FDCA, respectively, and >5 mole %;
PECTS50 (i.e. a polyester copolymer prepared from PET with 50 mole % of CHDM and SA), which is the same as PECFS50 (i.e. a polyester copolymer prepared from PEF with 50 mole % of CHDM and SA).

A preferred embodiment of the present invention is a polyester copolymer A obtainable by, or obtained by, a process according to the invention, in particular selected from a polyester copolymer comprising dicarboxylic acid-derived monomer units and diol-derived monomer units in a 1:1 ratio, having a number average molecular weight, as measured by gel permeation chromatography with PMMA standards as reference material, of 16500 daltons or more and having low (equal to or lower than 5% crystallinity) or no crystallinity:
(a) in the range from equal to or more than 10 mole % to equal to or less than 60 mole %, based on the total amount of diol-derived monomer units within the polyester copolymer, of one or more primary diol monomer units (in particular CHDM-derived units);
(b) in the range from equal to or more than 40 mole % to equal to or less than 90 mole %, based on the total amount of diol-derived monomer units within the polyester copolymer, of a monomer unit derived from ethylene glycol;
(c) optionally up to 5 mole %, based the total amount of diol-derived monomer units within the polyester copolymer, of a monomer unit derived from diethylene glycol; and either (d1) or (d2):
(d1) from equal to or more than 40 mole % to 90 mole % based on the total amount of dicarboxylic acid-derived monomer units within the polyester copolymer, of a monomer unit derived from terephthalic acid, the remainder of the dicarboxylic acid-derived monomer units being a monomer unit derived from furandicarboxylic acid; or
(d2) from equal to or more than 40 mole % to 90 mole % based on the total amount of dicarboxylic acid-derived monomer units within the polyester copolymer, of a monomer unit derived from furandicarboxylic acid, the remainder of the dicarboxylic acid-derived monomer units being a monomer unit derived from terephthalic acid; and
(e) optionally up to 5 mole %, based the total amount of dicarboxylic acid-derived monomer units within the polyester copolymer, of a monomer unit derived from isophthalic acid; and
(f) optionally equal to or more than 0 mole % to equal to or less than 20 mole %, based the total amount of diol-derived monomer units within the polyester copolymer, of a monomer unit derived from 1,3-propanediol, 1,4-butanediol, 1,5-pentanediol, 1,6-hexanediol, diethyleneglycol, neopentylglycol, 2,3:4,5-di-O-methylene-galactitol or 2,4:3,5-di-O-methylene-D-mannitol.

The polyester copolymer A obtainable according to the process of the invention can suitably be combined with additives and/or other (co) polymers and therefore the invention further provides a composition comprising said polyester copolymer and in addition one or more additives and/or one or more additional other (co) polymers.

Such composition can for example comprise, as additive, nucleating agents. These nucleating agents can be organic or inorganic in nature. Examples of nucleating agents are talc, calcium silicate, sodium benzoate, calcium titanate, boron nitride, zinc salts, porphyrins, chlorin and phlorin.

The composition according to the invention can also comprise, as additive, nanometric (i.e. having particles of a nanometric size) or non-nanometric and functionalized or non-functionalized fillers or fibres of organic or inorganic nature. They can be silicas, zeolites, glass fibres or beads, clays, mica, titanates, silicates, graphite, calcium carbonate, carbon nanotubes, wood fibres, carbon fibres, polymer fibres, proteins, cellulose fibres, lignocellulose fibres and nondestructured granular starch. These fillers or fibres can make it possible to improve the hardness, the stiffness or the permeability to water or to gases. The composition can comprise from 0.1% to 75% by weight, for example from 0.5% to 50% by weight, of fillers and/or fibres, with respect to the total weight of the composition. The composition can also be of composite type, that is to say can comprise large amounts of these fillers and/or fibres.

The composition can also comprise, as additive, opacifying agents, dyes and pigments. They can be chosen from cobalt acetate and the following compounds: HS-325 Sandoplast® Red BB, which is a compound carrying an azo functional group also known under the name Solvent Red 195, HS-510 Sandoplast® Blue 2B, which is an anthraquinone, Polysynthren® Blue R and Clariant® RSB Violet.

The composition can also comprise, as additive, a processing aid for reducing the pressure in the processing device. A mould-release agent, which makes it possible to reduce the adhesion to the equipment for shaping the polyester, such as the moulds or the rollers of calendering devices, can also be used. These agents can be selected from fatty acid esters and amides, metal salts, soaps, paraffins or hydrocarbon waxes. Specific examples of these agents are zinc stearate, calcium stearate, aluminium stearate, stearamide, erucamide, behenamide, beeswax or Candelilla wax.

The composition can also comprise other additives, such as stabilizers, etc. as mentioned herein above.

In addition, the composition can comprise one or more additional polymers other than the one or more polyester copolymers according to the invention. Such additional polymer(s) can suitably be chosen from the group consisting of polyamides, polystyrene, styrene copolymers, styrene/acrylonitrile copolymers, styrene/acrylonitrile/butadiene copolymers, polymethyl methacrylates, acrylic copolymers, poly(ether/imide)s, polyphenylene oxides, such as poly(2,6-dimethylphenylene oxide), polyphenylene sulfide, poly(ester/carbonate)s, polycarbonates, polysulphones, polysulphone ethers, polyetherketones and blends of these polymers. The composition can also comprise, as additional polymer, a polymer which makes it possible to improve the impact properties of the polymer, in particular functional polyolefins, such as functionalized polymers and copolymers of ethylene or propylene, core/shell copolymers or block copolymers. The compositions according to the invention can also comprise, as additional polymer(s), polymers of natural origin, such as starch, cellulose, chitosans, alginates, proteins, such as gluten, pea proteins, casein, collagen, gelatin or lignin, it being possible or not for these polymers of natural origin to be physically or chemically modified. The starch can be used in the destructured or plasticized form. In the latter case, the plasticizer can be water or a polyol, in particular glycerol, polyglycerol, isosorbide, sorbitans, sorbitol, mannitol or also urea. Use may in particular be made, in order to prepare the composition, of the process described in the document WO 2010/010282A1.

These compositions can suitably be manufactured by conventional methods for the conversion of thermoplastics. These conventional methods may comprise at least one stage of melt or softened blending of the polymers and one stage of recovery of the composition. Such blending can for example be carried out in internal blade or rotor mixers, an external mixer, or single-screw or co-rotating or counter-rotating twin-screw extruders. However, it is preferred to carry out this blending by extrusion, in particular by using a co-rotating extruder. The blending of the constituents of the composition can suitably be carried out at a temperature ranging from 220 to 300° C., preferably under an inert atmosphere. In the case of an extruder, the various constituents of the composition can suitably be introduced using introduction hoppers located along the extruder.

The invention also relates to an article comprising a polyester copolymer A according to the invention or a composition comprising a polyester copolymer A according to the invention and one or more additives and/or additional polymers.

The polyester copolymer A may conveniently be used in the manufacturing of articles such as films, fibres, injection moulded parts and packaging materials, such as for example receptacles. The use of the polyester copolymer A is especially advantageous where such films, fibres, injection moulded parts or packaging materials need to be heat-resistant or cold-resistant. The article can be a fibre for use in for example the textile industry. These fibres can be woven, in order to form fabrics, or also nonwoven. As said, the article can be a film, or a sheet. These films or sheets can be manufactured by calendering, cast film extrusion or film blowing extrusion techniques. These films can be used for the manufacture of labels or insulators. This article can be manufactured from the polyester copolymer or a composition comprising a polyester copolymer and one or more additives and/or additional polymers using conventional conversion techniques. The article can also be a container for transporting gases, liquids and/or solids. The containers concerned may be baby's bottles, flasks, bottles, for example sparkling or still water bottles, juice bottles, soda bottles, carboys, alcoholic drink bottles, medicine bottles or bottles for cosmetic products, dishes or also lids. These containers can be of any size. The polyester copolymer A may be particularly suitable for example for low temperature storage and deep-freezer applications.

The article may for example be suitably manufactured by extrusion-blow moulding, thermoforming or injection-blow moulding.

The present invention therefore also conveniently provides a method for manufacturing an article, comprising the use of one or more polyester copolymers A according to the invention and preferably comprising the following steps: 1) the provision of a polyester copolymer A obtainable according to the process of this invention; 2) melting said polyester copolymer, and optionally one or more additives and/or one or more additional polymers, to thereby produce a polymer melt; and 3) extrusion-blow moulding, thermoforming and/or injection-blow moulding the polymer melt into the article.

The article can also be manufactured according to a process comprising a stage of application of a layer of polyester in the molten state to a layer based on organic polymer, on metal or on adhesive composition in the solid state. This stage can be carried out by pressing, overmoulding, lamination, extrusion-lamination, coating or extrusion-coating.

The invention is further illustrated by the following non-limiting examples.

### EXAMPLES

### List of Abbreviations

AD=adipic acid
BDO=1,4-butanediol
DEG=Diethyleneglycol
DSC=differential scanning calorimetry
FDCA=2,5-furandicarboxylic acid
GPC=gel permeation chromatography
HFIP=hexafluoro-2-propanol
MEG=(Mono) Ethyleneglycol
Mn=number average molecular weight
Mw=weight average molecular weight
PDI=polydispersity index
PDO=1,3-propanediol
PEF=polyethylene furan-2,5-dicarboxylate
PEDFA=Poly(ethylene-diethylene) furanoate adipate
PEDTA=Poly(ethylene-diethylene) terephthalate adipatePET=polyethyleneterephthalate
PMMA=poly(methyl methacrylate)
SA=succinic acid
TCE=1,1,2,2-tetrachloroethane
TCE-d2=1,2-dideutero-1,1,2,2-tetrachloroethane
Tg=glass transition temperature

### Analytical Methods:

In the below examples, the weight average molecular weight (Mw) and the number average molecular weight (Mn) have been determined by means of gel permeation chromatography (GPC). GPC measurements were performed at 35° C. For the calculation PMMA standards were used as reference material. As eluent HFIP was used at 1 mL/min. The GPC measurements were carried out under these conditions on a Hitachi Chromaster 5450 with a Agilent HPLC system equipped with two PFG 7 micrometer (μm) Linear M (300×7.5 mm) columns. Calculation of the molecular weights was carried out with Astra 6 Software.

The glass transition temperature of the polyester polymers and copolymers in the below examples was determined using differential scanning calorimetry (DSC) with heating rate 10° C./minute in a nitrogen atmosphere. In the second heating cycle, a glass transition, (Tg), was recorded.

The content of the monomer units in the polyester polymers and copolymers of the below examples was determined by proton nuclear magnetic resonance (¹H NMR). The content of diol and diacid monomer units was determined using deutero-dichromethane as a solvent, and dichloromethane as a reference.

### Example 1 Preparation of PEDTA from PET

13.8 mg of butyltin hydroxide oxide (0.07 mmol), 6.00 g of DEG (56.54 mmol), 7.50 g of AD (51.32 mmol) and 19.51 g of PET (commercially available RAMA PET N180, 101.54 mmol) were weighed into a 100 mL glass reactor equipped with a mechanical stirrer, nitrogen gas inlet, a distillation head that connects a receiver to collect the condensation products. The glass reactor was heated by means of an oil bath.
1) The reactor contents were heated in a nitrogen flowing atmosphere (30 mL/min); as soon as the oil temperature reached 240° C., stirring was started with 30 rpm. After 15 minutes, the temperature was increased to 245° C.; kept for 15 minutes, while the stirring was increased to 100 rpm; subsequently the temperature was increased to 255° C., kept for 20 minutes, then stirring was increased to 150 rpm. The temperature and stirring rate were maintained for about 200 minutes during which the reactor contents melted and changed into a clear liquid.
2) The temperature was increased to 255° C. and stirring continued at 100 rpm for about 60 minutes.
3) After starting reduced pressure at 200 mbar, within 15 minutes the pressure was reduced to lower than 1 mbar in at least 2 steps, at the same time the temperature was increased to 260-265° C. The reaction time at this stage depended on the polymer viscosity. After about 120 minutes, the torque reached 25 Ncm at 30 rpm, nitrogen gas was then introduced until ambient pressure was reached and the stirring was stopped, after which the PEDTA polymer could be taken out of the reactor and analyzed. Analytic results: Tg=9.7° C. based on DSC; Proton NMR showed that 38.6 mol % DEG based on total diol; 31.9 mol % adipic acid based on total diacid. Results are summarized in Table 1.

TABLE 1

| Feed | | | PEDTA | | | | | |
|---|---|---|---|---|---|---|---|---|
| | AD/ | DEG/ | DEG/ | AD/total | Mn | Mw | | |
| PET/AD/DEG | (PET + AD) | (PET + AD) | total diol | diacid | (GPC) | GPC) | | |
| (mole ratio) | (mole ratio) | (mole ratio) | (mole %) | (mole %) | (g/mol) | (g/mol) | Mw/Mn | Tg (° C.) |
| 1.98/1/1.10 | 33.6/100 | 36.9/100 | 38.6 | 31.9 | 39600 | 85200 | 2.15 | 9.7 |

### Example 2 Preparation of PEDFA from PEF

Example 1 was repeated with PEF instead of PET as starting polyester. The reaction conditions were all the same.

Results are summarized in Table 2.

TABLE 2

| Feed | | | PEDFA | | | | | |
|---|---|---|---|---|---|---|---|---|
| | AD/ | DEG/ | DEG/ | AD/total | Mr | Mw | | |
| PEF/AD/DEG | (PEF + AD) | (PEF + AD) | total diol | diacid | (GPC) | GPC) | | |
| (mole ratio) | (mole ratio) | (mole ratio) | (mole %) | (mole %) | (g/mol) | (g/mol) | Mw/Mn | Tg (° C.) |
| 1.98/1/1.10 | 33.6/100 | 37.0/110 | 41.1 | 32.8 | 36000 | 82800 | 2.30 | 20.8 |

1. A polymerization process for the production of a polyester copolymer A comprising simultaneously reacting a polyester (i) with one or more diols (ii) and one or more dicarboxylic acids or any esters thereof (iii),
wherein the polyester (i) is polyethylene terephthalate, polyethylene furanoate, a mixture of polyethylene terephthalate and polyethylene furanoate, or polyethylene terephthalate-co-furanoate;
and
wherein no terephthalic acid or ester thereof is added as a dicarboxylic acid or ester thereof (iii) if the polyester (i) is polyethylene terephthalate; and
wherein the one or more diols (ii) is/are selected from primary diols selected from C3-C18 aliphatic diols; and
wherein the components (i) and (ii) are used in sufficient quantities to produce a polyester copolymer A comprising at least 40 mole % of ethylene glycol derived from the starting polyethylene terephthalate, polyethylene furanoate or polyethylene terephthalate-co-furanoate, and at least 5 mole %, of monomers derived from said primary diols, the percentages based on the total amount of diol-derived monomer units in polyester copolymer A; and
wherein the process comprises heating the polyester (i), the one or more primary diols (ii) and the one or more dicarboxylic acids or any esters thereof (iii) to form a melt;
to generate a polyester A comprising monomer units derived from the polyester (i), from the one or more primary diols (ii) and from the one or more dicarboxylic acids or any esters thereof (iii), having a number average molecular weight, as measured by gel permeation chromatography with PMMA standards as reference material, of 16500 daltons or more.

2. The process of claim 1, wherein the polyester (i) is polyethylene furanoate or polyethylene terephthalate-co-furanoate.

3. The process of claim 1, wherein the one or more primary diols (ii) is/are selected from linear, cyclic or branched, saturated C3-C12 aliphatic diol compounds, the hydroxyl groups being at least attached to non-neighboring carbon atoms, and from 1,3-propanediol, 1,4-butanediol, 1,5-pentanediol, 1,6-hexanediol, diethyleneglycol, neopentylglycol, cyclohexanedimethanol, and acetals of polyols, especially C6 polyols, and particularly 2,3:4,5-di-O-methylene-galactitol, 2,4:3,5-di-O-methylene-D-mannitol, 2,4:3,5-di-O-methylene-D-glucitol, 2,3:4,5-di-O-isopropylidene-galactitol, 2,4:3,5-di-O-isopropylidene-D-mannitol and 2,4:3,5-di-O-isopropylidene-D-glucitol.

4. The process of claim 1, wherein the one or more dicarboxylic acids or any esters thereof (iii) is/are selected from one or more of furandicarboxylic acid, isophthalic acid, C2-C18 aliphatic dicarboxylic acids which may be linear, cyclic or branched and saturated, and/or monoesters and/or diesters thereof, and if polyester (i) is polyethylene furanoate the dicarboxylic acid or any esters thereof (iii) can also be terephthalic acid and/or monoesters and/or diesters thereof.

5. The process of claim 1, wherein combinations of primary diols (ii) and dicarboxylic acids (iii) are selected from cyclohexanedimethanol and succinic acid; and 1,4-butanediol or 1,6-hexanediol, respectively, combined with furandicarboxylic acid or succinic acid, respectively.

6. The process of claim 1, wherein the one or more primary diols (ii) and the one or more dicarboxylic acids or any esters thereof (iii) are used in the process in a molar ratio of the total sum of diols to the total sum of dicarboxylic acids or any esters thereof of 1.5:1.0 to 1.0:1.0.

7. The process of claim 1, wherein in addition to the polyester (i), the one or more primary diols (ii) and the one or more dicarboxylic acids or any esters thereof (iii) also a monohydric alcohol in which the hydroxy group is the only reactive functional group, is added in 10-100 weight % with regard to the total weight of the other reactants (i), (ii) and (iii), wherein the monohydric alcohol has a boiling point of equal to or higher than 175° C. and an acid dissociation constant (pKa) of equal to or less than 12.0 and equal to or more than 7.0.

8. The process of claim 1, wherein the process comprises
(a) in a reaction vessel heating the polyester (i), the one or more primary diols (ii) and the one or more dicarboxylic acids or any esters thereof (iii) to a certain temperature for a certain period of time until a clear melt forms;
(b) continuing the esterification/transesterification reaction while removing condensation products at a pressure of 1 to 5 bar;
(c) reducing the pressure in the vessel of step (b) to a vacuum of lower than 20 mbar, with continued stirring for a certain period of time; and
optionally during step (c) further increasing the temperature by 10 to 50° C.

9. A polyester copolymer A obtainable by a process according to claim 1, in particular selected from a polyester copolymer comprising dicarboxylic acid-derived monomer units and diol-derived monomer units in a 1:1 ratio, having a number average molecular weight, as measured by gel permeation chromatography with PMMA standards as reference material, of 16500 daltons or more and having equal to or lower than 5% crystallinity or no crystallinity:
(a) in the range from equal to or more than 10 mole % to equal to or less than 60 mole %, based on the total amount of diol-derived monomer units within the polyester copolymer, of one or more primary diol monomer units;
(b) in the range from equal to or more than 40 mole % to equal to or less than 90 mole %, based on the total amount of diol-derived monomer units within the polyester copolymer, of a monomer unit derived from ethylene glycol;
(c) optionally up to 5 mole %, based the total amount of diol-derived monomer units within the polyester copolymer, of a monomer unit derived from diethylene glycol;
and either (d1) or (d2):
(d1) from equal to or more than 40 mole % to 90 mole % based on the total amount of dicarboxylic acid-derived monomer units within the polyester copolymer, of a monomer unit derived from terephthalic acid, the remainder of the dicarboxylic acid-derived monomer units being a monomer unit derived from furandicarboxylic acid; or
(d2) from equal to or more than 40 mole % to 90 mole % based on the total amount of dicarboxylic acid-derived monomer units within the polyester copolymer, of a monomer unit derived from furandicarboxylic acid, the remainder of the dicarboxylic acid-derived monomer units being a monomer unit derived from terephthalic acid; and
(e) optionally up to 5 mole %, based the total amount of dicarboxylic acid-derived monomer units within the polyester copolymer, of a monomer unit derived from isophthalic acid; and
(f) optionally equal to or more than 0 mole % to equal to or less than 20 mole %, based the total amount of diol-derived monomer units within the polyester copolymer, of a monomer unit derived from 1,3-propanediol, 1,4-butanediol, 1,5-pentanediol, 1,6-hexanediol, diethyleneglycol, neopentylglycol, 2,3:4,5-di-O-methylene-galactitol or 2,4:3,5-di-O-methylene-D-mannitol.

10. A composition comprising the polyester copolymer A of claim 9, and in addition one or more additives and/or one or more additional other (co) polymers.

11. An article comprising a composition comprising a polyester copolymer A according to claim 10 and one or more additives and/or additional polymers.
